(19) United States
(12) Patent Application Publication
(10) Pub. No.: US 2007/0242620 A1
(43) Pub. Date: Oct. 18, 2007

(54) Method, System and Device for Measuring Performance Parameters of Multiprotocol Label Switching Network

(75) Inventor: Suping Zhai, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/751,920

(22) Filed: May 22, 2007

Related U.S. Application Data
(63) Continuation of application No. PCT/CN06/01288, filed on Jun. 12, 2006.

(30) Foreign Application Priority Data
Jun. 13, 2005 (CN) 200510076664.7
Nov. 17, 2005 (CN) 200510114860.9

(51) Int. Cl. H04L 12/26; H04J 3/14

(52) U.S. Cl. 370/252; 370/249

(57) ABSTRACT

Embodiments of the present invention provides a method for measuring performance parameters of MultiProtocol Label Switching (MPLS) network, including: sending a performance parameter measurement packet carrying first information for measuring a performance parameter of the MPLS network to a second party; measuring the performance parameter of the MPLS network according to the first information in the performance parameter measurement packet. The embodiments of the invention also provide a system and a device for measuring performance parameters of the MPLS network.

### CROSS-REFERENCE TO RELATED APPLICATIONS

This is a continuation of International Appl. No. PCT/CN2006/001288, filed Jun. 12, 2006, which claims the benefit of Chinese Patent Appl. No. 200510076664.7, filed Jun. 13, 2005 and Chinese Patent Appl. No. 200510114860.9 filed Nov. 17, 2005.

### BACKGROUND OF THE INVENTION

1. Field of the Technology

The present invention relates to the field of measuring performance parameter of communication network, and more particularly, to a method, a system and a device for measuring performance parameters of a MultiProtocol Label Switching (MPLS) network.

2. Background of the Invention

In the practical application of the MPLS network, the measurement of performance parameters is important for obtaining the Quality of Service (QoS) of the MPLS network exactly, that is, the QoS of the MPLS network may be obtained exactly by measuring the performance parameters. Therefore, the Internet Engineering Task Force (IETF) put forwards demands for measuring the performance parameters of the MPLS network in the contribution “draft-ietf-mpls-oam-requirements-05.txt”, which mainly deals with two demands as follows:

firstly, it is required to measure the transmission properties of Label Switching Path (LSP) of the MPLS network so as to check the conformity of the Service Level Agreement (SLA) of the MPLS network and the serving capability of the MPLS network;

secondly, the measurement of the performance parameters such as a frame loss parameter, a frame delay parameter and a frame delay jitter parameter of the MPLS network makes it better to implement MPLS network layout, improves the serving capability of the MPLS network, and enhances the performance of the MPLS network.

The International Telecommunication Union (ITU) defines the connectivity check, mismatch check and mis-merging check of the LSP of the MPLS network in recommendation ITU-T Y.1711, and the availability of the LSP is defined in detail. However, there is no solution available for measurement satisfying the two demands above, i.e. at present there is no method for measuring the performance parameters, such as the frame loss parameter, the frame delay parameter and the frame delay jitter parameter of the MPLS network.

### SUMMARY OF THE INVENTION

An embodiment of the present invention provides a method for measuring performance parameters of an MPLS network.

A method for measuring performance parameters of a MultiProtocol Label Switching (MPLS) network, includes:

sending, by a first party, a performance parameter measurement packet carrying first information for measuring a performance parameter of the MPLS network to a second party;

measuring, by the second party, the performance parameter of the MPLS network according to the first information in the performance parameter measurement packet.

Another embodiment of the present invention provides a system for measuring performance parameters of a MultiProtocol Label Switching (MPLS) network, including:

a first device for sending a performance parameter measurement packet carrying first information for measuring a performance parameter of the MPLS network;

a second device for measuring the performance parameter of the MPLS network according to the first information in the performance parameter measurement packet.

Another embodiment of the present invention provides a device, including:

a first module, for receiving from another device a performance parameter measurement packet carrying first information for measuring a performance parameter of a MultiProtocol Label Switching (MPLS) network, and

a second module, for measuring the performance parameter of the MPLS network according to the first information.

As can be seen from the above, a performance parameter measurement packet for measuring the performance parameters of the MPLS network is constructed, the packet carrying the information for measuring the performance parameters of the MPLS network, thus the performance parameters of the MPLS network may be measured.

### BRIEF DESCRIPTION OF THE DRAWINGS

FIG. 1 is a flowchart illustrating the method for measuring the performance parameters of the MPLS network in accordance with an embodiment of the present invention.

### EMBODIMENTS OF THE INVENTION

To make the technical solution and merits of the present invention more apparent, embodiments of the present invention will be described in detail with reference to the accompanying drawings.

To measure the performance parameters of the MPLS network, a performance parameter measurement packet is set in accordance with an embodiment of the present invention. The performance parameter measurement packet may be a loopback request packet or a loopback reply packet. The structure of the loopback request packet is shown in Table 1 and the structure of the loopback reply packet is shown in Table 2.

TABLE 1

| Function | | Sequence | | Timestamp | Timestamp | | |
|---|---|---|---|---|---|---|---|
| Type | Reserved | Number | LSP TTSI | Sent | Received | Padding | BIP 16 |
| 1 octets | 1 octets | 2 octets | 20 octets | 4 octets | 4 octets | 10 octets | 2 octets |

TABLE 2

| Function | Sequence | | Timestamp | Timestamp | | |
|---|---|---|---|---|---|---|
| type | Number | LSP TTSI | Sent | Received | Padding | BIP 16 |
| 1 octets | 3 octets | 20 octets | 4 octets | 4 octets | 10 octets | 2 octets |

When measuring the performance parameters of the MPLS network, the sender constructs a loopback request packet shown in Table 1 and sends the loopback request packet to the receiver. When constructing the loopback request packet, it may include no Timestamp Received, and the Timestamp Sent may be the time-of-day of the clock of the sender, i.e. one hour selected from 1 to 24 hours is set as the Timestamp Sent. The Function type may be set as the type of the request packet, and the LSP TTSI (Trace Terminal Source Indicator) may be set as an identity of the sender. The BIP 16 may be set as the check value calculated using the algorithm set in advance, and the Padding may be set as the label of MPLS LSP, which makes the loopback request packet reach the receiver.

When measuring the performance parameters of the MPLS network, upon receiving the loopback request packet shown in Table 1 sent by the sender, the receiver may acquire the performance parameters of the MPLS network measured unidirectionally according to the information carried in the loopback request packet. Upon measuring and obtaining the performance parameters of the MPLS network of the sender, the receiver may also construct and send the loopback reply packet shown in Table 2 to the sender, which makes it possible for the sender to obtain the performance parameters of the MPLS network measured bi-directionally according to the information carried in the loopback reply packet. When constructing the loopback reply packet, it may include no Timestamp Sent, and the Timestamp Received may be set as the time-of-day of the clock of the receiver; the Function type may be set as the type of the reply packet, such as 0×06, and the LSP TTSI may be set as an identity of the receiver; the BIP 16 may be set as the check value calculated using the same algorithm preset in advance as that of the sender, and the Padding may be set as the label of the MPLS LSP, which makes the loopback reply reach the sender.

The packets shown in Table 1 or 2 are packets with Layer 2 frame encapsulation format, and the Layer 2 frame attribute may be constructed during the establishing or changing of the MPLS LSP between the sender and the receiver; the loopback request packet includes a source Media Access Control (MAC) address, Virtual Path Identifier (VPI)/Virtual Channel Identifier (VCI) and Data Link Connection Identifier (DLCI), and the loopback reply packet includes a destination MAC address, VCI and DLCI.

All of the processes for measuring the performance parameters of the MPLS network are performed when the MPLS network is in the available state. However, the MPLS network being in the available state does not mean that no frame will be lost when an MPLS LSP transmits packets. When the frame loss occurs in the MPLS network, i.e. that the frame loss occurs is determined according to the sequence number of the performance parameter measurement packet shown in Table 1 or 2, it is very likely that the MPLS network is still in the available state, because the MPLS LSP does not enter into the unavailable state until the MPLS LSP has been in the defect state for ten seconds without recovery according to the definition of the available state of the MPLS network in the ITU-T Y.1711; when the MPLS LSP recovers within ten seconds after entering into the defect state, it does not enter into the unavailable state, however, the frame loss may occur when packets are transmitted at this point. Therefore, in order to measure the frame delay parameter, the frame delay jitter parameter and the frame throughput parameter more exactly, a sequence number is set in the performance parameter measurement packet shown in Table 1 and 2 so that the sender can obtain the frame loss parameter of the receiver through measuring the sequence number set in the loopback reply packet and the receiver can obtain the frame loss parameter of the sender through measuring the loopback request packet. In this way, when the frame loss parameter of the MPLS LSP is not 0, the frame delay parameter, the frame delay jitter parameter and the frame throughput parameter will not be measured so as to avoid obtaining inaccurate performance parameters of the MPLS network.

Practically, the frame loss parameter may not be measured when the frame delay parameter, the frame delay jitter parameter or the frame throughput parameter is measured.

In accordance with an embodiment of the present invention, the process of setting and processing a sequence number is described below.

In Step 1, a sender, e.g. an Ingress Label Switching Router (Ingress LSR), sets sequence numbers respectively in loopback request packets sent successively to a receiver such an Egress LSR; the sequence number of a first loopback request packet sent to the receiver is set as 1, and a sequence number of a next loopback request packet is added by 1 based on the sequence number of a loopback request packet sent before the next loopback request packet.

In Step 2, a receiver may set the sequence number expected as 0 before receiving loopback request packets, i.e. before receiving the first loopback request packet sent by the sender; and detect, upon receiving the subsequent loopback request packets successively, whether the sequence numbers carried in the subsequent loopback request packets are subject to the rule as follows:

a next sequence number expected=(the sequence number carried in the loopback request packet received currently+1)mod 2¹⁶, wherein mod represents a remainder and 2¹⁶ is the maximum value of the sequence number, i.e. the sequence numbers of loopback request packets orderly cycle within the range from 1 to 2¹⁶ according to the sending order.

If the loopback request packets received in turn by the receiver all meet the rule above, no frame is lost when transmitting packets, and the frame loss parameter is 0; otherwise, the frame loss occurs in the MPLS network, and the frame loss parameter is determined according to the loss number.

Similarly, the sender may also determine the frame loss parameter of the packets sent by the receiver. At this point, the receiver orderly sets the sequence numbers increasing by degrees from 1 in the loopback reply packet according to the order of sending the loopback reply packets to the sender; upon receiving the loopback reply packet, the sender determines the frame loss parameter of the packet sent by the receiver according to the rule described in Step 2.

According to an embodiment of the present invention, if the receiver and the sender do not support the detection of the sequence numbers, the sender may set the sequence numbers carried in all loopback request packets sent as 0 or the receiver may set the sequence numbers carried in all loopback reply packets sent as 0, which makes it possible to notify the other party that the local party does not support the detection of the sequence numbers.

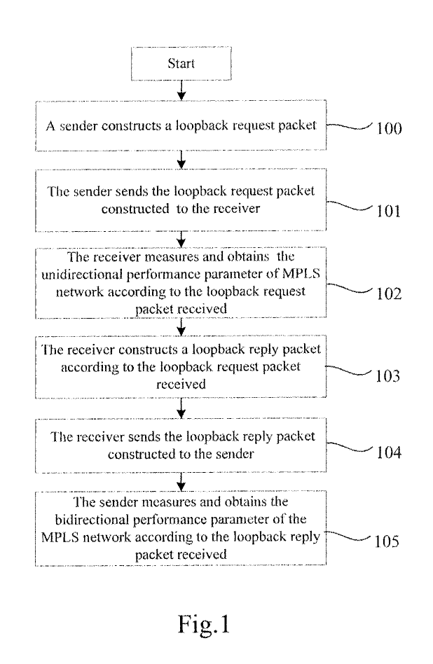

FIG. 1 is a flowchart illustrating the method for measuring performance parameters of the MPLS network in accordance with an embodiment of the present invention, the method is described below.

In Step 100, a sender constructs a loopback request packet.

The loopback request packet may be one or more.

The loopback request packet may be constructed using the packet structure shown in Table 1; it may also carry the sequence number for measuring whether the frame loss occurs.

In Step 101, the sender sends the loopback request packet to the receiver.

When multiple loopback request packets are constructed, the multiple loopback request packets may be sent to the receiver.

In Step 102, the receiver measures and obtains the unidirectional performance parameter of the MPLS network according to the loopback request packet received.

When there are multiple loopback request packets, the receiver receives the multiple loopback request packets in turn, measures and obtains the performance parameters of the MPLS network according to the multiple loopback request packets, thus more exact performance parameters of the MPLS network are obtained.

In Step 103, the receiver constructs a loopback reply packet according to the loopback request packet received.

When there are multiple loopback request packets, multiple loopback reply packets may be constructed correspondingly; when there is one loopback request packet, correspondingly, one loopback reply packet may be constructed.

The loopback reply packet may be constructed using the packet structure shown in Table 2; practically, it may also carry the sequence number for measuring whether the frame loss occurs.

In Step 104, the receiver sends the loopback reply packet constructed to the sender.

In Step 105, the sender measures and obtains the bidirectional performance parameter of the MPLS network according to the loopback reply packet received.

When there are multiple loopback reply packets, the sender receives the multiple loopback reply packets in turn, measures and obtains the bidirectional performance parameters of the MPLS network according to the multiple loopback reply packets, thus more exact performance parameters of the MPLS network are obtained.

The unidirectional performance parameter of the MPLS network may also be measured in accordance with an embodiment of the present invention, and Steps 103 to 105 may be omitted at this point.

The measurement for the unidirectional and the bidirectional performance parameter of the MPLS network is hereinafter described in detail.

It may be determined that no frame loss occurs before measuring the frame delay parameter and the frame delay jitter parameter, which makes the frame delay parameter and the frame delay jitter parameter measured more exactly. Practically, the frame delay parameter and the frame delay jitter parameter may be measured directly without determining whether the frame loss occurs.

The measurement for the unidirectional frame delay parameter is described below.

The sender sends the loopback request packet constructed according to Table 1 carrying the Timestamp Sent, the BIP 16 and the sequence number; upon receiving the loopback request packet, the receiver detects the validity according to the BIP 16 carried in the loopback request packet and detects whether the frame loss occurs according to the sequence number carried in the loopback request packet. If the loopback request packet passes the detection, the unidirectional frame delay parameter may be obtained according to the Timestamp Sent carried in the loopback request packet and the time when the receiver receives the loopback request packet. The time when the receiver receives the loopback request packet is set as RT and the Timestamp Sent carried in the loopback request packet is set as ST; the unidirectional frame delay parameter FD is calculated as: FD=RT−ST+t, where t represents the clock difference between the receiver and the sender.

According to the embodiment of the present invention, since more than one loopback request packet is sent and sent one by one, the receiver may calculate in turn a unidirectional frame delay parameter of each loopback request packet, and average the unidirectional frame delay parameters of all loopback request packets so as to obtain a final unidirectional frame delay parameter.

The measurement for the bidirectional frame delay parameter is described below.

The sender sends the loopback request packet constructed according to Table 1 carrying the Timestamp Sent, the BIP 16 and the sequence number; upon receiving the loopback request packet, the receiver sends to the sender the loopback reply packet constructed according to both Table 2 and the information carried in the loopback request packet while calculating the frame delay parameter according to the measurement for the unidirectional frame delay parameter, and the loopback reply packet carries the Timestamp Received, the BIP 16 and the sequence number. Upon receiving the loopback reply packet, the sender checks the packet validity according to the BIP 16 carried in the loopback reply packet and detects whether the frame loss occurs according to the sequence number carried in the loopback reply packet. If the loopback reply packet passes the detection, the bidirectional frame delay parameter may be obtained according to the Timestamp Received carried in the loopback reply packet and the time when the sender receives the loopback reply packet. The time when the sender receives the loopback reply packet is set as RT and the Timestamp Received carried in the loopback reply packet is set as ST; the bidirectional frame delay parameter FD is calculated as follows: FD=RT−ST+t, where t represents the clock difference between the receiver and the sender.

According to the embodiment of the present invention, since more than one loopback reply packet is sent one by one, the sender may calculate in turn a bidirectional frame delay parameter of each loopback reply packet, and average all the bidirectional frame delay parameters so as to obtain a final bidirectional frame delay parameter.

When measuring the bidirectional performance parameter of the MPLS network, if the processing time of checking the packet validity by the receiver can be acquired, the processing time of checking the packet validity by the receiver may be removed during the process of calculating the frame delay parameter so as to improve the precision for measuring the frame delay parameter.

The appropriate frame delay jitter parameter may be calculated using the frame delay parameter obtained through unidirectional or bidirectional measurement in accordance with the embodiments of the present invention.

When using the frame delay parameter obtained through the unidirectional measurement, the frame delay jitter parameter=FD2−FD1, i.e. the difference between the frame delay parameters of two adjacent loopback request packets.

When using the frame delay parameter obtained through the bidirectional measurement, the frame delay jitter parameter=FD2−FD1, i.e. the difference between the frame delay parameters of two adjacent loopback reply packets.

To improve the precision for measuring the frame delay jitter parameter, the method for averaging multiple measurement results of the frame delay jitter parameter may be adopted to measure the frame delay jitter parameter, and the average of the multiple measurement results is regarded as a final frame delay jitter parameter.

The process of measuring the frame loss parameter is described below.

The frame loss parameter refers to the difference between the number of the loopback request packets sent by the sender and the number of the loopback reply packets received by the sender within a period of time, e.g. 1 second.

The frame loss parameter=|FT2−FT1|−|FR2−FR1|, where |FT2−FT1| represents the number of the loopback request packets sent by the sender within the period of time, e.g. 1 second, and |FR2−FR1| represents the number of the loopback reply packets received by the sender within the period of time, e.g. 1 second.

The embodiments of the present invention are hereinafter described in detail with reference to the specific application examples. More particularly, the measurement for the frame loss parameter, the frame delay parameter, the frame delay jitter parameter and the frame throughput parameter is given in detail respectively.

To measure the frame loss parameter, the Frame Loss Measurement packet may be used as the performance parameter measurement packet in accordance with an embodiment of the present invention. The Frame Loss Measurement packet is transmitted in the MPLS network and includes a Frame Loss measurement Request (FL-Request) packet and a Frame Loss measurement Reply (FL-Reply) packet, the structure of which is shown in Table 3.

Different Function types are used to distinguish between the FL-Request packet and the FL-Reply packet in accordance with an embodiment of the present invention, and the Function types of the FL-Request packet and the FL-Reply packet should be determined based on the code of Y.1711.

TABLE 3

| Function | | Sequence | | | | | |
|---|---|---|---|---|---|---|---|
| type | Reserve | Number | LSP TTSI | IngressTxFrmCnt | EgressRxFrmCnt | Padding | BIP 16 |
| 1 octets | 1 octets | 2 octets | 20 octets | 4 octets | 4 octets | 10 octets | 2 octets |

The process of measuring the frame loss parameter is hereinafter described in detail with reference to the packet structure shown in Table 3.

Frame counters are set respectively at the sender, such as an Ingress LSR, and the receiver, such as an Egress LSR, for counting the packets sent and the packets received respectively. When measuring the frame loss parameter, the measurement for the frame loss parameter is enabled respectively at the Ingress LSR and the Egress LSR. The Ingress LSR sends the FL-Request packet carrying a packet sending counter value (IngressTxFrmCnt) periodically, and a packet receiving counter value (EgressRxFrmCnt) is meaningless in the FL-Request packet; upon receiving the FL-Request packet, the Egress LSR constructs and sends an FL-Reply packet to the Ingress LSR, and the FL-Reply packet copies the IngressTxFrmCnt carried in the FL-Request and carries the EgressRxFrmCnt; upon receiving the FL-reply packet, the Ingress LSR calculates the frame loss parameter: |FT2−FT1|−|FR2−FR1|, where |FT2−FT1| represents the sum of the FL-Request packets sent by the Ingress LSR when measuring the frame loss parameter and |FR2−FR1| represents the sum of the FL-Reply packets received by the Egress LSR.

To measure the frame loss parameter, frame loss parameter measurement enabling identifiers should be set in the Ingress LSR and the Egress LSR at the same time. According to the frame loss parameter measurement enabling identifiers, whether to measure the frame loss parameter is determined.

Besides, the interval for sending FL-Request packets is set in the Ingress LSR, and the default value of the interval may be set as 100 ms.

Values of other fields of the packet structure shown in Table 3 may be constructed based on the packet structure shown in Table 1 or 2.

To measure the frame delay parameter, a Frame Delay measurement Request (FD-Request) packet and a Frame Delay measurement Reply (FD-Reply) packet may be adopted as the performance parameter measurement packet in accordance with an embodiment of the present invention, the structure of which is shown in Table 4.

TABLE 4

| Function | | Sequence | | IngressTimeStamp | | |
|---|---|---|---|---|---|---|
| type | Reserve | Number | LSP TTSI | Sent | Padding | BIP 16 |
| 1 octets | 1 ctets | 2 octets | 20 octets | 4 octets | 10 octets | 2 octets |

Likewise, different Function types are used to distinguish between the FD-Request packet and the FD-Reply packet in accordance with an embodiment of the present invention, the Function types of such two packets are determined based on the code of Y.1711.

The Ingress Timestamp Sent of the packet shown in Table 4 is the time-of-day (with respect to the time of one day) relative to the clock of the sender; the Egress Timestamp Sent of the packet shown in Table 4 is the time-of-day (with respect to the time of one day) relative to the clock of the receiver.

When measuring the frame delay parameter, the measurement for the frame delay parameter is enabled respectively at the Ingress LSR and the Egress LSR. The Ingress LSR sends the FD-Request packet carrying the Ingress Timestamp Sent actively; upon receiving the FD-Request packet, the Egress LSR constructs a FD-Reply packet to reply to the Ingress LSR, and the FD-Reply packet copies the Ingress Timestamp Sent carried in the FD-Request packet.

To measure the frame delay parameter, frame delay parameter measurement enabling identifiers are set in the Ingress LSR and the Egress LSR in the same time, according to which whether to measure the frame delay parameter is determined. Besides, the interval for sending FD-Request packets is set in the Ingress LSR, and the default value of the interval may be set as 100 ms.

Values of other fields of the packet structure shown in Table 4 may be constructed based on the packet structure shown in Table 1 or 2.

Likewise, there are two methods of measuring the frame delay parameter, the unidirectional frame delay measurement and the bidirectional frame delay measurement, which are described below respectively.

In the method of the unidirectional frame delay measurement, the Ingress LSR sends the FD-Request packet carrying the Ingress Timestamp Sent; upon receiving the FD-Request packet, the Egress LSR checks the packet validity, for example, detects the sequence number; if the sequence number is not the sequence number expected, the FD-Request packet is omitted; if the FD-Request packet is determined to be valid, the time when receiving the FD-Request packet, i.e. the Egress Timestamp Received, and the Ingress Timestamp Sent carried in the FD-Request packet received are recorded to calculate the unidirectional frame delay parameter. The unidirectional frame delay parameter FD=RT−ST+t, where t represents the clock difference between the Ingress LSR and the Egress LSR.

In the method, reference clocks of the sender and the receiver are synchronous in the MPLS network, or the Egress LSR has known the clock difference between the sender and the receiver.

In the method of the bidirectional frame delay parameter measurement, the Ingress LSR sends the FD-Request packet carrying the Ingress Timestamp Sent; upon receiving the FD-Request packet, the Egress LSR constructs the FD-Reply packet. Upon receiving the FD-Reply packet, the Ingress LSR checks the packet validity, for example, detects the sequence number; if the sequence number is not the sequence number expected to be received, the FD-Reply packet is omitted; if the FD-Reply packet is determined to be valid, the time when receiving the FD-Reply packet, i.e. the Ingress Timestamp Received (RT), is recorded and compared with the Ingress Timestamp Sent (ST) carried in the FD-Reply packet received so as to acquire the bidirectional frame delay parameter FD=RT−ST. Since the bidirectional frame delay parameter includes the processing time of the receiver, the processing time may be removed during the process of measuring the frame delay parameter so as to guarantee the precision of measurement.

Therefore, to make the bidirectional frame delay parameter measurement more exact, two fields may be added in the FD-Request/FD-Reply packet, which is shown in Table 5.

TABLE 5

| Function | | Sequence | | IngressTimeStamp | EgressTimeStamp | EgressTimeStamp | | |
|---|---|---|---|---|---|---|---|---|
| type | Reserve | Number | LSP TTSI | Sent | Received | Sent | Padding | BIP 16 |
| 1 octets | 1 octets | 2 octets | 20 octets | 4 octets | 4 octets | 4 octets | 10 octets | 2 octets |

The information carried in the field of the Ingress Timestamp Sent represents the timestamp when the Ingress LSR sends the FD-Request packet; the information carried in the field of the Egress Timestamp Received represents the timestamp when the Egress LSR receives the FD-Request packet; the information carried in the field of the Egress Timestamp Sent represents the timestamp when the Egress LSR sends the FD-Reply packet.

If the Ingress Timestamp Received represents the time when the Ingress LSR receives the FD-Reply packet, and the equation for calculating the frame delay parameter at this point is as follows: FD=(Ingress Timestamp Received−Ingress Timestamp Sent)−(Egress Timestamp Sent−Egress Timestamp Received).

The frame delay parameter may be calculated more exactly with the two time fields added, without including the time for processing packets by the receiver.

The measurement for the frame delay jitter parameter is directed below.

According to an embodiment of the present invention, the frame delay jitter parameter expected may be acquired by using two successive frame delay parameters.

When using the unidirectional frame delay parameter, the frame delay jitter parameter=FD2−FD1, i.e. the difference between the frame delay parameters of two adjacent the FD-Request packets.

When using the bidirectional frame delay parameter, the frame delay jitter parameter=FD2−FD1, i.e. the difference between the frame delay parameters of two adjacent the FD-Reply packets.

The method of averaging the multiple values of measurement may also be adopted to acquire the statistical average.

In the measurement of the frame throughput parameter, the throughput is related to the size of the frame transmitting a packet; the throughput may be measured using the Frame throughput Request (LB-Req) packet and the Frame throughput Reply (LB-Res) packet, which includes: filling the data with variant lengths in the Padding field, increasing the sending rate of the LB-Req packet gradually with respect to each packet with different lengths, and recording whether the frame loss occurs in the LB-Res. The sending rate of the LB-Req packet is recorded when the frame loss occurs apparently, which is the throughput.

The formats of the LB-Req and LB-Res packets for measuring the throughput are shown in Table 6.

TABLE 6

| Function | | Sequence | LSP | | |
|---|---|---|---|---|---|
| type | Reserve | Number | TTSI | Padding | BIP 16 |
| 1 octets | 1 octets | 2 octets | 20 octets | At least | 2 octets |
| | | | | 18 octets | |

Of course, the sequence number carried may be adopted to determine whether the frame loss occurs in the LB-Res packet; if the LB-Res packet carries the packet sending counter value and the packet receiving counter value, the formula of |FT2−FT1|−|FR2−FR1| may also be adopted for the determining.

To sum up, the measurement of the performance parameters of the MPLS network is described in detail in accordance with the embodiments of the present invention, and particularly includes the measurement of the frame delay parameter, the frame delay jitter parameter, the frame throughput parameter and the frame loss parameter, which provides an important reference for planning an MPLS network and provides the basis for detecting the conformity of Service Level Agreement (SLA) in the existing MPLS network.

The technical solutions and advantages of the present invention have been further described in detail by the above embodiments. The performance parameter measurement packet is transmitted on the LSP of the MPLS network, which enables one end of the LSP to measure the performance parameters of the MPLS network according to the information in the performance parameter measurement packet sent by the other end of the LSP. The performance parameters of the MPLS network measured may include the frame loss parameter, the frame delay parameter, the frame delay jitter parameter and/or the frame throughput parameter. Therefore, the performance parameters of the MPLS network may be measured according to the method in accordance with the embodiments of the present invention.

It should be appreciated that the foregoing are only embodiments of the present invention and are not for use in limiting the present invention. Any modification, equivalent substitution, and improvement within the spirit and principle of the present invention should be covered in the protection scope thereof.

What is claimed is:

1. A method for measuring performance parameters of a MultiProtocol Label Switching (MPLS) network, comprising:
sending, by a first party, a performance parameter measurement packet carrying first information for measuring a performance parameter of the MPLS network to a second party;
measuring, by the second party, the performance parameter of the MPLS network according to the first information in the performance parameter measurement packet.

2. The method of claim 1, wherein the performance parameter measurement packet is a frame loss measurement packet which is a Frame Loss measurement Request (FL-Request) packet or a Frame Loss measurement Reply (FL-Reply) packet.

3. The method of claim 2, wherein the first information for measuring the performance parameter of the MPLS network comprises: a sequence number for measuring a frame loss parameter; and
the process of measuring the performance parameter of the MPLS network comprises:
upon receiving frame loss measurement packets sent by the first party successively, detecting whether the sequence number carried in the frame loss measurement packet received is equal to an expected sequence number, calculating a next expected sequence number according to an equation of the next expected sequence number=(the sequence number carried in the frame loss measurement packet received+1) mod a maximum value of the sequence number; wherein the sequence number carried in each of the frame loss measurement packets sent successively is increased by 1 each time;
if the sequence number carried in the frame loss measurement packet received is equal to the expected sequence number, the frame loss parameter being 0;
otherwise, determining the frame loss parameter according to the difference between the sequence number carried in the frame loss measurement packet received and the expected sequence number.

4. The method of claim 3, further comprising:
setting, by the first party, an initial value for the sequence number carried in the first frame loss measurement packet sent to the second party; and
setting, by the second party before receiving the first frame loss measurement packet, an initial value for the expected sequence number carried in the first frame loss measurement; wherein the initial value set by the first party is equal to the initial value set by the second party.

5. The method of claim 2, further comprising:
when the frame loss measurement packet is an FL-Reply packet, sending, by the second party, an FL-Request packet carrying second information for measuring a performance parameter of the MPLS network to the first party before sending by the first party the FL-Reply packet to the second party.

6. The method of claim 5, wherein the first information for measuring the performance parameter of the MPLS network comprises: a packet sending counter value for indicating the number of the FL-Request packets sent by the second party, and a packet receiving counter value for indicating the number of the FL-Reply packets received by the second party; and the second information comprises the packet sending counter value;
the process of measuring the performance parameter of the MPLS network comprises: calculating difference between the packet sending counter value and the packet receiving counter value within a period of time, wherein the difference is the frame loss parameter.

7. The method of claim 2, further comprising: determining whether to measure the frame loss parameter according to a frame loss parameter measurement enabling identifier set by the first party or the second party.

8. The method of claim 1, wherein the performance parameter measurement packet is a Frame Delay measurement Request (FD-Request) packet, and the first information comprises: a Timestamp Sent for measuring a frame delay parameter and indicating a timestamp when the first party sends the FD-Request packet; and
the process of measuring the performance parameter of the MPLS network comprises: calculating difference between the Timestamp Sent and the time when the second party receives the FD-Request packet.

9. The method of claim 8, further comprising: calculating a sum of the difference and clock difference between the first party and the second party, wherein the sum is the frame delay parameter.

10. The method of claim 1, further comprising:
when the performance parameter measurement packet is an FD-Reply packet, sending, by the second party, an FD-Request packet carrying second information for measuring a performance parameter of the MPLS network to the first party before sending by the first party the FD-Reply packet to the second party.

11. The method of claim 10, wherein the first information comprises: a Timestamp Sent of the second party indicating a timestamp when the second party sends the FD-Request packet; and the process of measuring the performance parameter of the MPLS network comprises: calculating difference between the time when the second party receives the FD-Reply packet and the Timestamp Sent of the second party.

12. The method of claim 10, wherein the first information comprises: a Timestamp Sent of the second party indicating a timestamp when the second party sends the FD-Request packet, a Timestamp Received of the first party indicating a timestamp when the first party receives the FD-Request packet, and a Timestamp Sent of the first party indicating a timestamp when the first party sends the FD-Reply packet;
the process of measuring the performance parameter of the MPLS network comprises: calculating the frame delay parameter according to a formula of the frame delay parameter=(the time when the second party receives the FD-Reply packet−the Timestamp Sent of the second party)−(the Timestamp Sent of the first party−Timestamp Received of the first party).

13. The method of claim 8, further comprising: determining whether to measure the frame delay parameter according to a frame delay parameter measurement enabling identifier at the first party or the second party.

14. The method of claim 8, further comprising: calculating a frame delay jitter parameter of the MPLS network through calculating difference between two frame delay parameters measured through two frame delay measurement packets sent successively.

15. The method of claim 1, wherein the number of performance parameter measurement packets is more than one, the performance parameter measurement packets are frame throughput measurement packets, and the first information comprises: data with variant lengths for measuring a frame throughput parameter; a rate for sending the frame throughput measurement packets successively is increased gradually; and
the process of measuring the performance parameter of the MPLS network comprises: determining whether frame loss occurs; recording, when the frame loss occurs, the rate for sending the frame throughput measurement packets as the frame throughput parameter.

16. The method of claim 15, wherein the frame throughput measurement packets are Frame Throughput Request packets or Frame Throughput Reply packets.

17. A system for measuring performance parameters of a MultiProtocol Label Switching (MPLS) network, comprising:
a first device for sending a performance parameter measurement packet carrying first information for measuring a performance parameter of the MPLS network;
a second device for measuring the performance parameter of the MPLS network according to the first information in the performance parameter measurement packet.

18. A device, comprising:
a first module, for receiving from another device a performance parameter measurement packet carrying first information for measuring a performance parameter of a MultiProtocol Label Switching (MPLS) network, and
a second module, for measuring the performance parameter of the MPLS network according to the first information.

19. The device of claim 18, further comprising:
a third module, for sending a performance parameter measurement packet carrying second information for measuring a performance parameter of the MPLS network to another device.

20. The device of claim 18, wherein the performance parameter is a frame loss parameter and the performance parameter measurement packet is a frame loss measurement packet;
the second module comprises:
a first sub-module, for detecting whether a sequence number carried in a frame loss measurement packet received is equal to an expected sequence number;
a second sub-module, for calculating a next expected sequence number according to an equation of the next expected sequence number=(the sequence number carried in the frame loss measurement packet received+1)mod a maximum value of the sequence number, wherein the sequence number carried in each of frame loss measurement packets sent successively is increased by 1 each time;
a third sub-module, for determining the frame loss parameter according to difference between a sequence number carried in a frame loss measurement packet received and an expected sequence number.

21. The device of claim 19, further comprising:
a first counter for counting a packet receiving counter value for indicating the number of performance parameter measurement packets received by the first module, and a second counter for counting a packet sending counter value for indicating the number of performance parameter measurement packets sent by the third module;
wherein the second module comprises a fourth sub-module, for calculating difference between the packet sending counter value and the packet receiving counter value within a period of time, wherein the difference is a frame loss parameter.

22. The device of claim 18, wherein the second module comprises a fifth sub-module, for calculating difference between the time when the first module receives the performance parameter measurement packet and a Timestamp Sent carried in the first information for indicating when the performance parameter measurement packet is sent; wherein the difference is a frame delay parameter.

23. The device of claim 19, wherein the second module comprises a sixth sub-module, for calculating difference between a Timestamp Sent for indicating when the third module sends the performance parameter measurement packet carrying the second information and the time the first module receives the performance parameter measurement packet carrying the first information; wherein the difference is a frame delay parameter.

24. The device of claim 21, wherein the second module comprises a seventh sub-module, for calculating difference between two frame delay parameters measured through two frame delay measurement packets sent successively.

25. The device of claim 19, further comprising:
a fourth module, for measuring a rate for sending performance parameter measurement packets carrying the second information, increasing the rate each time for sending a performance parameter measurement packet carrying the second information;
wherein the second module comprises: an eighth sub-module, for measuring a frame loss parameter; a ninth sub-module, for recording the rate as a frame throughput parameter when frame loss occurs.
